(19) United States
(12) Patent Application Publication
(10) Pub. No.: US 2006/0019854 A1
(43) Pub. Date: Jan. 26, 2006

(54) Paper mill cleaner with taed

(75) Inventors: Jeff R. Dyer, Racine, WI (US); Robert E. Ebbeler, Cincinnati, OH (US); Vikram Asher, Cincinnati, OH (US)

Correspondence Address: WOOD, HERRON & EVANS, LLP, 2700 CAREW TOWER, 441 VINE STREET, CINCINNATI, OH, 45202, US

(73) Assignee: JohnsonDiversey. Inc., Sturtevan, WI (US)

(21) Appl. No.: 10/896,087

(22) Filed: Jul. 21, 2004

(51) Int. Cl. C11D 3/00

(52) U.S. Cl. 510/376

(57) ABSTRACT

A detergent composition adapted to clean paper making equipment without the use of chlorinated compounds includes a phosphate sequesterant system, a non-foaming nonionic surfactant, a polyacrylic acid detergent polymer and, as a bleaching source, a combination of a peroxy compound and tetraacetylethylenediamine. Suitable peroxy compounds include sodium percarbonate, sodium perborate, and sodium persulfate. This composition, when added to water and circulated through paper making equipment effectively cleans the equipment, removing pitch and other stickies as well as dirts, greases, and the like.

### BACKGROUND OF THE INVENTION

Cleaning paper making equipment is relatively difficult. The paper making equipment is complex and includes coating applicators, holding tanks, conduits, sprayers with nozzles and screens. The paper coatings build up on the equipment and must be removed. These coating are generally acrylic or latex based and include, in addition to the polymer solids, clays and other coating components. Other soils present include pitch and stickies. Most cleaning compositions for paper making machines include chlorinated products.

Chlorinated products, however, are generally undesirable. They can cause corrosion. Frequently, the effluent must be specially treated and, further, the chlorinated compounds can adversely effect portions of the equipment such as the felts. Accordingly, it is desirable to eliminate these chlorine containing compositions without reducing efficacy of the detergent composition.

### SUMMARY OF THE INVENTION

The present invention is premised on the realization that a detergent that effectively cleans paper making equipment includes a phosphate sequesterent system, a non-foaming nonionic surfactant, polyacrylic acid detergent polymer and a bleaching source wherein the bleaching source is a combination of a peroxy compound and tetraacetylethylenediamine (TAED). The peroxy compound in combination with a TAED acts to release a bleaching agent in aqueous solutions. However, these can be stored in a solid composition and remain stable. The present invention further includes the method of cleaning paper making equipment using this detergent formulation.

### DETAILED DESCRIPTION OF THE INVENTION

The present invention is a chlorine free granular-cleaner adapted to be mixed with water and circulated through paper making equipment to clean the equipment.

The composition operates best at alkaline pHs, generally 9 to 12, preferably 10 to 12. Accordingly, the present invention will incorporate a sufficient amount of base to establish the desired pH at use concentration. Suitable bases include sodium hydroxide and potassium hydroxide with sodium hydroxide being preferred. Other components of the composition such as metasilicates will also contribute to the alkalinity. Generally, the composition will include 0-25% sodium hydroxide by weight on a dry basis with, preferably, about 5.0%.

In addition to the base, the present invention can include an alkaline metal metasilicate, such as sodium metasilicate or potassium metasilicate with sodium metasilicate preferred. The metasilicate acts to improve detergency, acts as an anti-redeposition agent, and is an alkaline agent. Preferably, the sodium metasilicate will be present in an amount from 0-25% by weight on a dry basis with about 15% by weight preferred.

Further, the composition will include a phosphate based sequestering agent, in particular an alkali metal tri-polyphosphates. Sodium tri-polyphosphate is preferred. This composition improves the detergency of the composition, acts as an anti-redeposition agent as well as, of course, a sequesterant. The phosphate based detergency additive will be present in an amount from about 10-50% by weight, with about 10-25% by weight being preferred.

The present invention will further include a non-ionic surfactant. Suitable non-ionic surfactants include the linear alcohol ethoxolates, ethoxylated alkylphenols and the polyoxyalkylene block copolymers. The preferred nonionics for use in the present invention are low-foaming nonionics, in particular linear alcohol ethoxolates and block copolymers. Generally, such ethoxylates having carbon chain lengths of about 9 to about 14 with about 3 to about 12 ethylene oxide groups per molecule are preferred. One preferred non-ionic surfactant is Neodol 91-6 which has a carbon length of 9 to 10 and 6 ethylene oxide groups per molecule. A preferred EO/PO block copolymer is Pluronic N-3. The non-ionic surfactant lowers the surface tension in order to aid in cleaning. Preferably, since this is going to be used in association with paper making equipment, it will be an FDA compliant or GRAS listed non-ionic. The non-ionic should be present in an amount of from 0-10% with about 1% preferred.

In addition, the present invention can include an anionic surfactant, such as the alkyl benzene sulfonic acids and sulfonates. One preferred anionic is Triton DF20 which is a modified ethoxylated anionic surfactant. However, these tend to be foaming and therefore are less preferred. When used, these should be present in an amount of 1-10% by weight.

The composition of the present invention will also include a water soluble polymer which acts as a sequesterant and an anti-deposition aid. These are water soluble polymers of acrylic acid and/or methacrylic acid. Generally they have a molecular weight of 4,000 to 6,000. Suitable polymers include Goodrite K 739 and Accusol 445 MD. This should be present in an amount from about 1% to about 10% with about 3% being preferred.

Further, the present invention may include an additional sequesterant. Suitable additional sequesterants would include sodium gluconate, sodium glucoheptonate, ethylenediamine tetraacetic acid, and nitrilo tri-acetic acid. Preferred sequesterants are sodium gluconate and sodium glucoheptonate with sodium gluconate being preferred. The additional sequesterants should be present in an amount of from about 0 to 10% with about 3% being preferred.

The composition can also include various fillers such as sodium sulfate, sodium carbonate, or the like.

The present invention will include a nonchlorine based bleaching agent. The bleaching agent is a combination of two components, a peroxy composition and tetraacetylethylenediamine which acts as an activator. Suitable peroxy compounds include alkali metal perborates and alkali metal percarbonates and alkali metal persulfate. The peroxy compound should form 5 to 50% of the present invention, with about 25% preferred. Sodium percarbonate is the preferred percarbonate. The ratio of percarbonate to TAED on a mole basis should be about 1:2 to 1:3. The tetraacetylethylenediamine should in turn be present at 1 to 30% with about 12.5% being preferred when sodium percarbonate is the peroxy compound. The ratio of perborate to TAED should be in the range of 1:4 to 1:6. Thus, when the peroxy source is perborate, additional TAED is preferred.

The composition of the present invention is formed by simply dry blending the individual components with no preferred order of addition. This is continued until a uniform finished product is obtained.

The dry-blended cleaning composition can simply be added into a vessel to occupy 10 to 50% of the vessel's volume. Water is then added to fill the vessel to 80% of its capacity and agitated until a uniform slurry or solution is formed. Mixing can continue for 30 minutes or longer. The concentrated slurry is then added to the soiled paper mill system for end use dilution and cleaning. The end use dilution should be about from 0.25 to about 2% detergent composition with about 0.5% by weight preferred. This will be circulated through the paper making equipment for a period of time of about 1 to about 4 which should effectively clean the paper making surfaces. During this time, the temperature of the solution should be maintained from room temperature to about 150° F. The pH of the solution should be about 10 to 12 during the cleaning process. Upon completion of the cleaning cycle, the water is simply drained through a sanitary sewer.

In particular, one preferred formulation of the present invention is the following:

| INGREDIENT | FORMULA (% by weight) |
|---|---|
| sodium hydroxide | 5.0% |
| sodium metasilicate | 15.0% |
| sodium tripolyphosphate | 25% |
| nonionic surfactant | 1.0% |
| sodium percarbonate | 25% |
| tetraacetylethylenediamine | 12.5% |
| sodium gluconate | 3.0% |
| polyacrylic acid detergent polymer | 3.0% |
| sodium sulfate | 10.5% |

The present invention will be appreciated in light of the following detailed examples.

### EXAMPLE 1

A detergent composition was blended with the following components.

| Ingredients | Percent |
|---|---|
| Sodium Tripolyphosphate | 25.00 |
| Sodium Metasilicate | 10.00 |
| Sodium Sulfate | 7.00 |
| Sodium Gluconate | 3.00 |
| Polyacrylic Acid, Sodium Salt | 3.00 |
| Pluronic N-3 | 1.00 |
| Sodioum Percarbonate | 10.00 |
| Tetraacetylethylenediamine (TAED) | 10.00 |
| LAS Flakes | 1.00 |
| Sodium Hydroxide | 20.00 |

A 2% solution was formed with a water temperature of 95° F., and pre-mixed for 30 minutes. Stainless steel coupons with a thin film of a blend of polyvinyl alcohol, latex, starch, resin and calcium stearate which were oven dried over night and allowed to sit for two days were then soaked in the solution for 30 minutes and rinsed under lukewarm tap water. The composition cleaned about 95% the soil. Further, this outperformed a commercially available chlorinated alkaline detergent.

### EXAMPLE 2

Detergent formulations having the composition of the detergent tested in Example 1 with 1% and 0.5% solutions were formulated. Samples of soiled forming wire were soaked in the two solutions along with commercially available products. At both concentrations, the product of the present invention performed as well or better than the commercially available products.

### EXAMPLE 3

A 2.5% solution of the following detergent compound was formulated.

| Ingredients | Percent |
|---|---|
| Sodium Tripolyphosphate | 20.00 |
| Sodium Metasilicate | 10.00 |
| Sodium Sulfate | 0.00 |
| Sodium Gluconate | 3.40 |
| Polyacrylic Acid, Sodium Salt | 3.30 |
| Linear Alcohol Ethoxylate | 3.30 |
| Sodioum Perborate | 30.00 |
| Tetraacetylethylenediamine (TAED) | 30.00 |

1″×6″ strips of a soiled forming wire were soaked in the solution for 30 minutes at 100° F. This removed a significant portion of the build up from the forming wire.

These Examples demonstrate that the detergent formulation of the present invention effectively cleans the build up which occurs on paper making equipment. Further, it performs as well or better than chlorine containing detergents.

This has been a description of the present invention along with the preferred method of practicing the present invention. However, the invention itself should only be defined by the appended claims,

Wherein we claim:

1. A method of cleaning paper making equipment comprising circulating a cleaning solution through said equipment, said cleaning solution comprising water and dissolved detergent, said detergent comprising a base, a metasilicate, a phosphate sequesterant, a non-foaming nonionic surfactant, and at least one additional sequestering agent selected from the group consisting of a gluconate, a glucoheptonate, EDTA and NTA, a peroxy compound, and tetraacetylethylenediamine in an amount effective to activate said peroxy composition to form a bleaching agent.

2. The method claimed in claim 1 wherein said base comprises a hydroxide.

3. The method claimed in claim 1 wherein said peroxy composition is selected from the group consisting of perborates, percarbonates and persulfates.

4. The method claimed in claim 1 wherein said additional sequesterant is a gluconate.

5. The method claimed in claim 1 wherein said detergent further comprises a polyacrylic acid detergent polymer.

6. The method claimed in claim 5 wherein said detergent comprises
at least comprising at least about 10% sodium tripolyphosphate,
at least about 5% of said peroxy composition,
at least about 1% tetraacetylethylenediamine,
at least about 1% gluconate, and
at least about 1% polyacrylic acid detergent polymer.

7. The method claimed in claim 1 wherein said detergent is combined with water at an amount of about 0.25 to 2% by weight detergent.

8. The method claimed in claim 7 wherein said composition is circulated through said paper making equipment for at least about 1 hour.

9. A chlorine free detergent composition comprising, by weight
0-25% alkali metal hydroxide,
0-25% alkali metal metasilicate,
10-50% alkali metal tripolyphosphate,
1-10% nonionic surfactant,
5-50% peroxy compound,
1-30% tetraacetylethylenediamine,
1-10% of a sequesterant selected from the group consisting of gluconates, glucoheptonates, EDTA and NTA, and
1-10% detergent polymer and filler.

10. The composition claimed in claim 9 having the following formula, by weight
5.0% sodium hydroxide,
15.0% sodium metasilicate,
b 25.0% sodium tripolyphosphate,
1.0% nonionic surfactant,
25.0% sodium percarbonate,
12.5% tetraacetylethylenediamine,
3.0% sodium gluconate,
3.0% polyacrylic acid detergent polymer, and
10.5% filler.
